(19) United States
(12) Patent Application Publication
(10) Pub. No.: US 2011/0052943 A1
(43) Pub. Date: Mar. 3, 2011

(54) ACCUMULATOR HAVING PROLONGED SERVICE LIFE

(76) Inventors: Jürgen Hofmann, Kamenz (DE); Magnus Mickel, Wittichenau (DE); Günter Eichinger, Altenstadt (DE); Tim Schäfer, Niedersachswerfen (DE); Andreas Gutsch, Ludinghausen (DE)

(21) Appl. No.: 12/841,503

(22) Filed: Jul. 22, 2010

Related U.S. Application Data
(63) Continuation of application No. 12/497,087, filed on Jul. 2, 2009.

(30) Foreign Application Priority Data
Jul. 3, 2008 (DE) 10 2008 031 538.9

(51) Int. Cl. H01M 10/50; B29C 39/10

(52) U.S. Cl. 429/50; 429/62; 429/61; 264/330

(57) ABSTRACT

An electrical energy storage device includes at least one galvanic cell partly surrounded by a cell sheath, at least one heat-conducting device effectively connected to the galvanic cell, the heat-conducting device being suitable for supplying heat energy to the cell and/or conducting heat energy from the cell, a cell holding device enclosing an interior space at least partially with a wall, the interior space being suitable for accommodating each galvanic cell, and the cell sheath being at least partly effectively connected to the wall, at least one first measurement device suitable for acquiring a temperature at a prespecified position of the galvanic cell, and a control device suitable for evaluating a signal of each first measurement device that is present and/or for controlling the heat-conducting devices, heat-conducting apparatus being situated between the cell sheath and at least one of the wall of cell holding device and an additional cell sheath.

### PRIORITY CLAIM AND REFERENCE TO RELATED APPLICATION

The application claims priority under 35 U.S.C. §120 and is a Continuation of prior pending U.S. patent application Ser. No. 12/497,087, filed Jul. 2, 2009.

### BACKGROUND

The present invention relates to an accumulator having a prolonged service life. The present invention is described in relation to a lithium-ion accumulator for supplying power to the drive of a motor vehicle. However, it is also to be noted that the present invention can also be used in batteries without lithium, and/or independently of motor vehicles.

From the prior art, accumulators are known having galvanic cells for storing electrical energy. The electrical energy supplied to an accumulator is converted into chemical energy and is stored. This conversion is subject to losses. During this conversion, in addition, irreversible chemical reactions occur that cause aging of the accumulator. As the temperature increases inside a galvanic cell of an accumulator, in addition to faster conversion of the energy the aging is also accelerated. In particular during acceleration of an electrically driven motor vehicle, high electrical currents can be drawn from the accumulator over short periods of time. These high electrical currents also occur when the deceleration of a motor vehicle is supported by electrical devices, and the energy obtained is supplied to the accumulator.

Here it is disadvantageous that these brief high currents cause premature aging of the accumulator.

### SUMMARY

Therefore, the present invention is based on the object of increasing the service life of accumulators operated in this way. According to the present invention, this is achieved through the subject matter of the independent claims. Advantageous specific embodiments and developments are the subject matter of the subclaims.

A device according to the present invention for storing electrical energy has at least one galvanic cell. This cell is surrounded at least partly by a cell sheath. In addition, the device has at least one heat conduction device that is effectively connected to this galvanic cell. This heat conduction device is suitable for supplying heat energy to this galvanic cell and/or conducting heat energy away from this galvanic cell. In addition, the device has a cell holding device. This holding device surrounds at least one inner space with a wall. This space is suitable for accommodating this at least one galvanic cell. Here, the cell sheath is at least partially effectively connected thermally to said wall. In addition, the device has at least one first measurement device. This measurement device is suitable for acquiring a temperature at a prespecified position of this galvanic cell. In addition, the device has a control device. This control device is suitable at least for the evaluation of the signals of the first measurement devices that are present, and/or for controlling heat conduction devices that are present. Here, heat-conducting means are situated between this cell sheath and the wall of this cell holding device and/or another cell sheath that is present.

The device for storing electrical energy having at least one galvanic cell is a primary or secondary battery that provides electrical energy through conversion from chemical energy. If the device is fashioned as a secondary battery, it is also suitable for receiving electrical energy, converting it into chemical energy, and storing it as chemical energy. In addition to at least one galvanic cell, the device has various further devices for ordered operation, and supplies a drive mechanism of a motor vehicle.

This device according to the present invention has at least one galvanic cell, but preferably has a large number of cells, connected in parallel and/or in series, in order to increase the electrical voltage and/or the stored charge quantity. Also, in order to achieve a prespecified operating voltage, it is preferably the case that, for example, each four galvanic cells are connected in series as a group. A plurality of such groups is preferably connected in parallel, and store a larger charge quantity.

Such a galvanic cell is surrounded by a cell sheath. This cell sheath protects the galvanic cell and its chemical components from harmful external influences, for example from the atmosphere. This cell sheath is preferably formed by a gas-tight and electrically insulating solid material or layer composite, for example a welded foil. Preferably, the cell sheath has thin walls and is thermally conductive. This cell sheath preferably surrounds the galvanic cell as tightly as possible. It is not necessary for this galvanic cell to be completely surrounded by the cell sheath. The cell sheath may also surround only parts of this galvanic cell.

A heat-conducting device has an increased heat conductivity, and is used to supply thermal energy to an effectively connected galvanic cell. This is advantageous in particular given low ambient temperatures. In addition, a heat-conducting device preferably conducts thermal energy away from an effectively connected galvanic cell. This preferably takes place if a high electrical current is supplied to or taken from this galvanic cell. These high currents cause heating of the galvanic cell; an excessively high cell temperature will shorten the service life of the cell. By means of an effectively connected heat-conducting device, heat is preferably removed from the galvanic cell, protecting the cell. These high currents occur predominantly during acceleration phases of the motor vehicle, or during deceleration phases thereof if the deceleration is carried out for example by an electric motor that acts as a generator. “Effectively connected” is to be understood as meaning that the galvanic cell stands at least in thermal contact with said heat-conducting device.

The device has a cell holding device. The latter has an interior space that is geometrically matched to the galvanic cells that it accommodates, and a wall that at least partially surrounds this interior space. This cell holding device preferably accommodates additional devices in addition to the galvanic cells, such as measuring devices, control devices, and other devices or components required for the operation of the accumulator. The wall also permits connection to and fastening to the motor vehicle. The wall is also preferably made thin for reasons of cost. The wall preferably surrounds the accommodated galvanic cells tightly and in a thermally conductive manner, so that the cell sheaths of the galvanic cells exchange large heat outputs with this wall. These galvanic cells preferably emit heat to the wall or absorb heat from the wall. The device has at least first measurement devices that determine the temperature at a prespecified point of a galvanic cell. Here a plurality of measurement means is preferably also connected to a measurement device in order to acquire temperatures at various positions of a galvanic cell. This measurement device is suitable for receiving the signals from the measurement means at all times. Due to practical considerations, and in order to reduce the quantity of data, the acquisition preferably takes place only from time to time. This is also a function of the thermal capacities and coefficients of heat transfer that are involved. A first measurement device forwards signals to a control device that is also present. Preferably, this control device triggers the acquisition of temperatures by a first measurement device as a function of the operating conditions.

The device has a control device. This control device controls at least the first measurement devices that are present and evaluates the signals thereof. This takes place on the basis of prespecified computing rules. These rules take into account different characteristics of the individual measurement means. The control device is also suitable for controlling heat-conducting devices that are present. Here, depending on the operational state of a galvanic cell, individual heat-conducting devices, or a plurality thereof, are switched. The functions of this control device of the device according to the present invention can also be taken over by another control device or battery management system.

A heat-conducting means preferably has an increased heat conductivity and is fashioned as a layer that is as thin as possible. Suitable here are pastes that are applied for example using a brush or a roller, foils that are laid in place or glued on, or thin-cut mats. These heat-conducting means are used to prevent air enclosures, the enlargement of heat-transmitting surfaces, and thus the increase in transmitted quantities of heat. The cooling or heating of the galvanic cells accommodated in the interior space is improved by these heat-conducting means. Advantageously, heat-conducting means are applied onto surfaces that are used to transfer heat from one device to another. Particularly preferably, heat-conducting means are situated between individual galvanic cells and/or between galvanic cells and for example the wall of the cell holding device.

Advantageously, the device according to the present invention is operated in such a way that its control device first acquires the temperature at a prespecified location of a galvanic cell. As a function of this temperature, this control device switches a heat-conducting device on or off. Preferably, the control device switches conveyor devices for fluids on or off. In this way, a premature aging of a device for storing electrical energy is remedied, and the service life of the device is prolonged.

Advantageously, this control device is connected to a storage device. This storage device is used to store acquired data, evaluated measurement values, and/or computing rules. Together with a measurement value or an evaluated measurement value, another value is stored that represents the time at which the measurement was made. Preferably, specifications or target values for a measured parameter, such as the temperature of a cell, are stored in this storage device.

Particularly advantageously, the device has a control device, an allocated storage device, and at least one first measurement device. This control device is suitable for forming a difference from a measurement value, or a signal of this first measurement device, and a prespecified value. As a function of this temperature difference, this control device switches a heat-conducting device on or off. Preferably, the control device switches conveyor devices for fluids on or off. In this way, premature aging of a device for storing electrical energy is remedied, and the service life of this device is prolonged.

The device according to the present invention is also advantageously equipped with at least one second measuring device. This second device is suitable for acquiring the charge or discharge current to or from an allocated galvanic cell, and communicating it to this control device. Here, the number of both measurement devices corresponds to the number of galvanic cells, but can preferably also be smaller. The acquisition of the current strength takes place constantly, but preferably in accordance with the specification of this control device as a function of the operating conditions.

Particularly advantageously, the device has a control device, an allocated storage device, at least one first measurement device, and at least one second measurement device. This control device is suitable for forming a difference of a measurement value, or signal of the first measurement device, and a prespecified value. In addition, this control device is suitable for combining the measurement values of a first measurement device with a signal of a second measurement device, using a stored computing rule. Given suitable combining of measured current strengths and determined temperatures, or temperature differences, the control device preferably estimates the future temporal development of the cell temperature using stored computing rules. Based on the expectation of a future change in temperature of a galvanic cell, the control device preferably switches heat-conducting devices and/or conveyor devices for a fluid on and/or off. For example, given a high discharge current during an acceleration phase of the motor vehicle, the control device switches on a conveyor device for a fluid, and/or a heat-conducting device, already before there is a noticeable increase in the temperature of a cell.

Preferably, one or more galvanic cells have a prismatic base surface, particularly preferably a rectangular base surface. Such rectangular galvanic cells can be brought into thermal contact with each other particularly well, and can be accommodated in the interior space particularly well. A galvanic cell preferably also has an essentially plate-shaped current conductor as a heat-conducting device. This current conductor conducts the electrical current away from the galvanic cell or into the galvanic cell. This current conductor is preferably metallic and has a high thermal conductivity. This high thermal conductivity brings it about that only low temperature gradients occur inside a current conductor, and high heat currents are conducted into or out of the galvanic cell. A first area of the current conductor is situated inside a galvanic cell.

A second area of the current conductor extends from this galvanic cell. In order to improve the carrying away or introduction of heat, this second area is at least as wide as the first area of the current conductor inside the galvanic cell. The current conductor is preferably plate-shaped, and is described by the thickness, width, and height/length of the plate. The height is measured along an edge of the plate-shaped current conductor that extends, via the first area and second area, out from the galvanic cell. Due to practical considerations, the second area of a current conductor is cooled, or heated, by heat conduction to a cooling body, or by convection. This cooling body is preferably thermally connected to the current conductor, preferably using a heat-conducting means. Preferably, a first fluid flows at least partly around this cooling body or this current conductor. As a function of the temperatures of, on the one hand, the first fluid that flows around in this way and, on the other hand, the current conductor or the cooling body, heat is supplied to, or taken away from, the galvanic cell. Preferably, the cooling body contains copper, particularly preferably copper and aluminum. Here, particularly preferably a copper-containing area of the cooling body stands in thermal contact with the current conductor, while fluid flows against an aluminum-containing area of this cooling body.

In order to increase the thermal or electrical conductivity of a plastic or artificial resin, for example metallic particles may be added to it. Depending on the function of the adjacent components, a heat-conducting means is preferably electrically insulating. An electrically insulating and simultaneously heat-conducting means having a prespecified form, known as a heating pad, comprises for example mica, various types of ceramic (e.g. Al₂O₃, BeO), silicon rubber, diamond, carbon nanotubes, polyimide, or some other plastic. Various adhesives are also suitable as heat-conducting means, after the addition of metallic particles. Here, a heat-conducting glue also materially bonds the adjacent components to one another.

In addition to the named current conductors, a galvanic cell preferably has active heat-conducting devices. These preferably have at least one fluid duct and a second fluid contained therein. This second fluid flows through this fluid duct, or is held tightly in this fluid duct if this fluid duct is a closed space. As a function of the prevailing temperatures and the chemical composition of the second fluid, this fluid is subject to changes in phase, preferably from liquid to gas or vice versa. In a specific embodiment, this second fluid is at first supplied to this first fluid duct with a prespecified temperature, and is conducted out again after emitting or absorbing heat. The fluid duct has a third area inside the cell or in thermal contact with this cell. The fluid duct preferably also has a fourth area outside the cell. Preferably, a third fluid flows at least partially around this fourth area, and/or this fourth area is connected in heat-conducting fashion to a cooling body. This third fluid also preferably flows against this cooling body.

The device preferably has a reservoir. This reservoir is for example connected to the cell receptacle. This reservoir has at least one closing device and is filled with a third substance. This closing device is suitable for being opened by this control device. Subsequently, this third substance flows out of the reservoir. This third substance then preferably exits in the direction of at least one galvanic cell, for example through a duct that is provided. After a specified time, or after a specified quantity of the third substance has flowed out, the control device closes said closing device. At the latest after coming into contact with this galvanic cell, the substance undergoes a change of phase in which heat energy is absorbed or emitted. The reservoir is preferably connected to a plurality of ducts that are oriented towards various galvanic cells. With the use of such ducts, as needed it is also possible to supply only single galvanic cells with this third substance. Cells supplied in this way are heated or cooled by the energy from the change of phase. Preferably, a closing device is additionally equipped with a temperature-sensitive switch, for example a bimetallic switch. Such a design advantageously enables the emission or absorption of heat energy even when the controlling, the heat-conducting device, and/or the fluid conveyor device is not ready for operation or has failed.

Advantageously, the wall of this cell holding device has at least one hardenable first substance, as well as embedded particles that are highly heat conductive. Advantageously, this wall is made thin in order to reduce the thermal resistance, and lies tightly against the galvanic cells. Particularly advantageously, the accommodated galvanic cells are surrounded by at least partial molding or casting by this wall, so that a good heat transition of the accommodated galvanic cells to the wall is present. Preferably, this wall has at least one second fluid duct. A fourth fluid, supplied with a prespecified temperature, flows through this second fluid duct. After leaving this second fluid duct, this fourth fluid is prepared for example by a cooling or heating device that is installed in the vehicle or is independent. Preferably, this wall has a prepared connection surface for thermal contact with a vaporizer or cooler. This latter device exchanges heat energy for example with the ambient air or with the climate control system of the motor vehicle.

Advantageously, the wall contains, at least in part, a second substance. This second substance is suitable for undergoing changes in phase during the operation of the accumulator and/or at a prespecified temperature. This second substance is for example contained in a prespecified space in or on the wall of the cell holding device. This wall contains this second substance for example at least partly or predominantly. A change of phase of this second substance takes place at a material-specific temperature, and thus also influences the temperature of a galvanic cell. Such a design of the wall of the cell holding device advantageously enables the emission or absorption of heat energy even when the controlling, the heat-conducting device, and/or the fluid conveyor device is not ready for operation or has failed.

The application of the present invention to secondary batteries, or accumulators, or to primary batteries having high power density or energy density, has advantages. Under conditions of operation that include brief high currents, such accumulators show noticeable changes in temperature, in particular increases in temperature. Noticeable and recurring increases in temperature cause the accumulator to age more rapidly. This is true in particular of nickel-metal hydride accumulators or lithium-ion accumulators. The design of such accumulators according to the present invention increases their service life through preventive measures for temperature control, i.e. for the planned temperature curve over time of the individual galvanic cells.

Advantageously, the cell holding device for a device according to the present invention is manufactured using a mold and at least one hardenable first substance. For this purpose, the galvanic cells that are to be accommodated are positioned relative to one another in this mold. Possible intermediate spaces between these galvanic cells are filled with heat-conducting means, preferably heat-conducting foils. Subsequently, these cells are pressed against one another in order to achieve a good thermal connection between the galvanic cells. Next, hollow spaces inside the mold are grouted with this hardenable first substance. Subsequently, this hardenable first substance is given time to harden.

### BRIEF DESCRIPTION OF THE DRAWINGS

Further advantages, features, and possible uses of the present invention result from the following description in connection with the Figures.

FIG. 1 shows an accumulator according to the present invention in a sectional view.

FIG. 2 shows a system according to the present invention of control and measurement devices.

### DETAILED DESCRIPTION

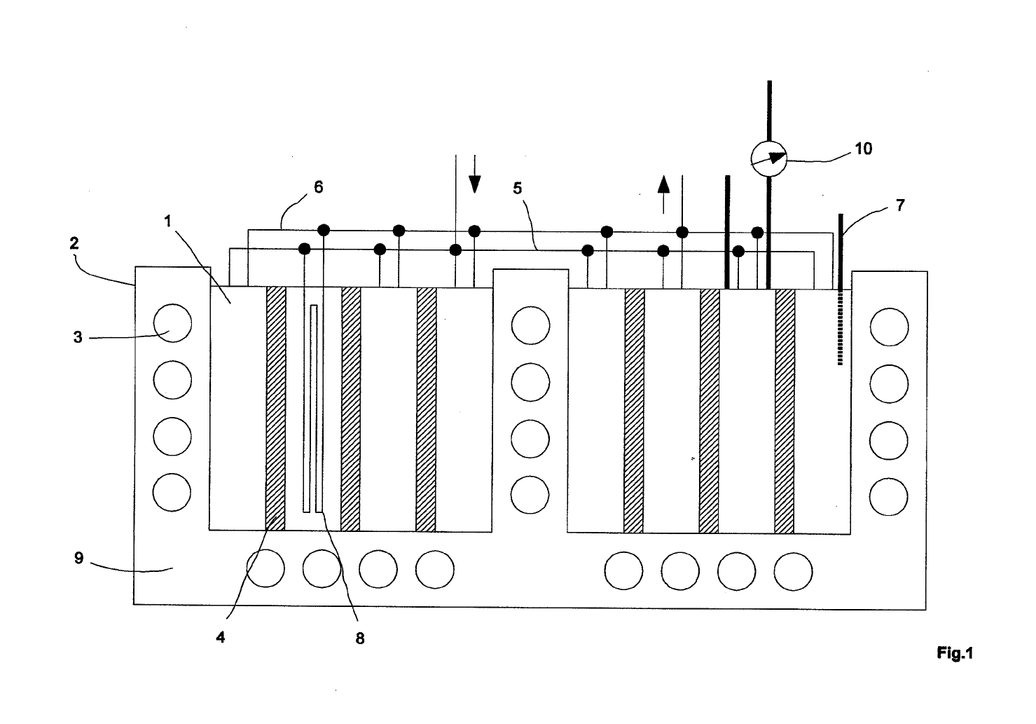

FIG. 1 shows a device according to the present invention for storing electrical energy, in a preferred specific embodiment. The representation is not to scale. The depicted accumulator has two groups of four galvanic cells each. The two groups are connected in parallel in order to increase the charge quantity. Within a group, four galvanic cells 1 are connected in series. However, the electrical wiring is not shown. Also not depicted are the individual cell sheaths, which are fashioned as gas-tight welded foils.

A heat-conducting device 8 is allocated to each galvanic cell 1. In this case, heat-conducting device 8 consists of a so-called microduct cooler 8. A tempered second fluid flows through the ducts of microduct cooler 8, the geometry of the duct, the material properties of the second fluid, and the flow speed of said fluid being selected such that the flow has a Reynolds number or Nusselt number that is as high as possible. In order to supply the microduct cooler, supply line 5 and line 6 are provided. As a function of the temperatures of galvanic cell 1 and this second fluid, heat is supplied to or conducted away from said galvanic cell 1, using microduct cooler 8.

In another specific embodiment (not shown), the microduct cooler is replaced by a so-called heat pipe. This entails other modifications in the design, without bringing it about that this specific embodiment does not have the features of the claims.

According to FIG. 1, galvanic cells 1 are housed by a cell holding device 2. The wall 9 of this device is thin and is made of a hardenable plastic, and surrounds the galvanic cells in such a way as to avoid air enclosures. The interior space of cell holding device 2 has two nests that are separated by a wall and that each accommodates four galvanic cells. The cell sheaths (not shown) are surrounded by wall 9 in such a way that the transmission of high heat currents between a galvanic cell 1 and wall 9 is possible. In wall 9 of cell holding device 2, ducts 3 are fashioned for a fourth fluid. These ducts are made in wall 9 during the manufacture of cell holding device 2. A fourth fluid, which can supply or conduct away heat, flows through these ducts 3. The devices for conveying the fluids are switched on and off by control device 11 (not shown).

As an example, in the Figure only a first measurement device 7, for acquiring a temperature, is shown. This is a thermocouple 7 whose contacts are connected to control device 11 (not shown). Although this is not shown, each of these galvanic cells 1 has its own thermocouple 7. In this specific embodiment of the accumulator, thermocouples 7 are each queried with a frequency of 100 Hz. The device also has two measurement devices 10. Depicted is an amperemeter 10 that measures the strength of the electrical current that is supplied to or taken from a galvanic cell 1.

A heat-conducting foil 4 is situated between the individual galvanic cells 1. This heat-conducting foil 4 is used to improve the thermal contact between the individual galvanic cells, partly by increasing the actual contact surfaces. In addition, this heat-conducting foil 4 also exerts elastic resetting forces on the galvanic cells in order to prevent undesirable movements thereof.

During the manufacture of cell holding device 2 from a hardenable plastic, using a mold, preferably a very good thermal contact is achieved between wall 9 and a galvanic cell 1 that stands in contact with this wall.

FIG. 1 does not show the adjacent or interacting devices for supplying the device. These include for example the coolant circuits that supply microduct cooler 8 as well as ducts 3. Also not shown are various parts attached to cell holding device 2 that are required for the problem-free functioning of the accumulator.

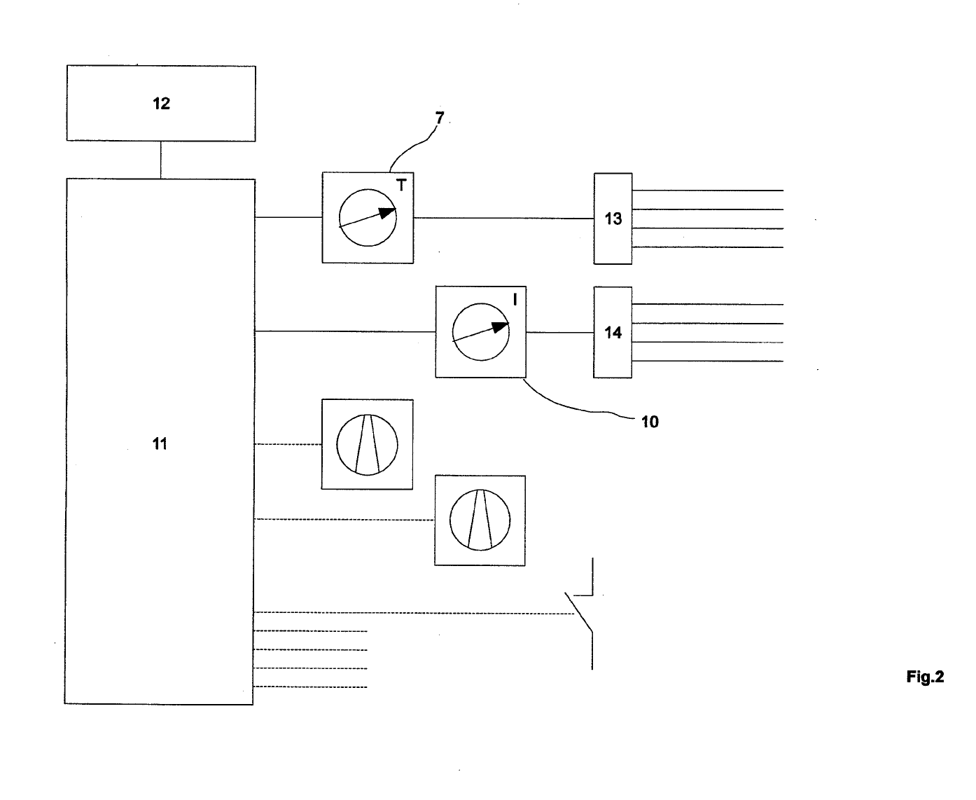

FIG. 2 shows a system according to the present invention of control and measurement devices for maintaining the temperature of the accumulator. Shown is a control device 11 to which a storage device 12 is allocated. In this storage device 12 there are stored computing rules, acquired and evaluated measurement values, and temperature specifications or target values. In addition, this storage device 12 contains specifications for controlling the temperature of the accumulator. With these specifications for temperature control, control device 11 is able to predictively switch on or off the devices that are present. A first measurement device 7, for acquiring temperatures of connected galvanic cells, is connected to control device 11. A changeover switch 13, to which the various thermocouples are connected, is connected to this first measurement device 7. In addition, a second measurement device 10 for acquiring electrical currents is connected to control device 11. A changeover switch 14, to which the various current-measuring devices are connected, is connected to this second measurement device 10. In addition, a series of conveyor devices for fluids, as well as control lines to various switches, are connected to control device 11.

In this design of the system of control and measurement devices, control device 11 is able to predictively carry out the temperature control of the accumulator during operation. Here, the functions of control device 11 can also be taken over by some other control device that is present, or by a higher-order battery management system.

What is claimed:

1. A device for storing electrical energy, comprising:
at least one galvanic cell that is at least partly surrounded by a cell sheath,
at least one heat-conducting device that is effectively connected to said galvanic cell, said heat-conducting device being suitable for at least one of supplying heat energy to said cell and conducting heat energy from said cell,
a cell holding device that encloses an interior space at least partially with a wall, said interior space being suitable for accommodating said at least one galvanic cell, and said cell sheath being at least partly effectively connected to said wall, at least one first measurement device suitable for acquiring a temperature at a prespecified position of said galvanic cell, and
a control device suitable at least for evaluating a signal of each said at least one first measurement device that is present and for controlling the heat-conducting devices that are present, heat-conducting means being situated between said cell sheath and at least one of the wall of said cell holding device and an additional cell sheath.

2. The device as recited in claim 1, characterized in that the device has at least one of at least one second measurement device that is suitable for acquiring the current strength of the electrical current into or from said galvanic cell, and communicating said current strength to said control device, and the device having a storage device that is allocated to said control device, said storage device being suitable for storing at least one of data and computing rules.

3. The device as recited in claim 1, characterized in that said at least one galvanic cell preferably has at least one of a prismatic construction and has, as heat-conducting device, at least one essentially plate-shaped current conductor having at least one first area situated inside the cell and a second area situated outside the cell, the second area being at least as wide as the first area, said second area preferably being effectively connected to a cooling body that contains at least one of copper and aluminum, and in that a first fluid preferably flows at least partly against said second area and/or said cooling body.

4. The device as recited in claim 1, characterized in that a heat-conducting means is fashioned with thin walls to be electrically insulating.

5. The device as recited in claim 1, characterized in that a heat-conducting means stands in surface contact with adjacent components.

6. The device as recited in claim 1, characterized in that said at least one galvanic cell has at least one heat-conducting device, and in that said heat-conducting device has at least one of a first fluid duct having a third area inside said cell or standing in effective connection to said cell, and has a fourth area outside said cell and has a second fluid contained in said first fluid duct, and in that said second fluid at least one of preferably flows inside said first fluid duct and is subject to changes of phase, and in that preferably a third fluid flows at least partly against said fourth area, and/or said fourth area stands in effective connection to a cooling body.

7. The device as recited in claim 1, characterized in that in addition the device has a reservoir that is at least partly filled with a third substance, and in that at specified temperatures, said third substance goes through changes in phase, said third substance preferably being at least one of electrically non-conductive, and said third substance particularly preferably containing CO₂, and in that said reservoir has at least one closing device that is suitable for being at least opened by said control device.

8. The device as recited in claim 1, characterized in that the wall of said cell holding device has at least one hardenable first substance, preferably plastic, and has embedded particles, the heat conductivity of said particles being at least as great as the heat conductivity of the hardenable first substance, and/or in that said galvanic cells are at least partly surrounded by casting by said wall, and/or in that said wall has at least one second fluid duct through which a fourth fluid flows, and/or in that the wall has a connecting surface for a thermally effective connection to a cooled and/or heated surface, for example a surface, provided for this purpose, of a vaporizer, and/or in that said wall has a second substance, said substance being suitable for passing through changes of phase during operation of the device and/or at a prespecified temperature.

9. The device as recited in claim 1, characterized in that said at least one galvanic cell has at least one of lithium and lithium ions, and/or in that preferably the electrolyte has lithium ions.

10. A method for operating the device as recited in claim 1, characterized in that said first measurement device acquires, at least at times, the temperature at a prespecified point of a galvanic cell, or said second measurement device acquires the strength of the electric current to or from a galvanic cell, and in that said control device determines the temperature difference from this acquired temperature and a temperature prespecified for this purpose, and in that said control device switches on or off at least one of a heat-conducting device and a fluid conveyor device as a function of at least one of the measured temperature, the determined temperature difference, and an acquired current strength.

11. A method for producing a cell holding device for a device as recited in claim 8, using a mold and at least one hardenable first substance, having the steps:
a) situation of the galvanic cells in said mold, intermediate spaces being filled by heat-conducting means and said cells subsequently being pressed against one another,
b) grouting of provided hollow spaces with said hardenable first substance,
c) hardening of said hardenable first substance.

12. The device as recited in claim 1, characterized in that a heat-conducting means is materially bonded to said adjacent components.

13. The device as recited in claim 1, characterized in that said galvanic cells are at least partly surrounded by casting by said wall.

14. The device as recited in claim 1, characterized in that said wall has at least one second fluid duct through which a fourth fluid flows.

15. The device as recited in claim 1, characterized in that the wall has a connecting surface for a thermally effective connection to at least one of a cooled and heated surface, for example a surface, provided for this purpose, of a vaporizer, and/or in that said wall has a second substance, said substance being suitable for passing through changes of phase during operation of the device and/or at a prespecified temperature.

16. The device as recited in claim 1, characterized in that said wall has a second substance, said substance being suitable for passing through changes of phase during at least one of operation of the device and at a prespecified temperature.
